(19) United States
(12) Patent Application Publication
(10) Pub. No.: US 2012/0099400 A1
(43) Pub. Date: Apr. 26, 2012

(54) ESTIMATING POSITION AND ORIENTATION OF AN UNDERWATER VEHICLE RELATIVE TO UNDERWATER STRUCTURES

(75) Inventors: Christian H. Debrunner, Conifer, CO (US); Alan K. Fettinger, Highlands Ranch, CO (US); Christopher L. Baker, Allison Park, PA (US)

(73) Assignee: LOCKHEED MARTIN CORPORATION, Bethesda, MD (US)

(21) Appl. No.: 13/280,843

(22) Filed: Oct. 25, 2011

Related U.S. Application Data
(60) Provisional application No. 61/406,424, filed on Oct. 25, 2010.

(51) Int. Cl. G01S 15/00

(52) U.S. Cl. 367/99

(57) ABSTRACT

A method and system that can be used for scanning underwater structures. For example, the method and system estimate a position and orientation of an underwater vehicle relative to an underwater structure, such as by directing an acoustic sonar wave toward an underwater structure, and processing the acoustic sonar wave reflected by the underwater structure to produce a three dimensional image of the structure. The data points of this three dimensional image are compared to a pre-existing three dimensional model of the underwater structure. Based on the comparison, a position and orientation of an underwater vehicle relative to the underwater structure can be determined.

This application claims the benefit of priority of U.S. Provisional Application No. 61/406,424, filed on Oct. 25, 2010, and entitled ESTIMATING POSITION AND ORIENTATION OF AN UNDERWATER VEHICLE RELATIVE TO UNDERWATER STRUCTURES, and which is herewith incorporated by reference in its entirety.

### FIELD

This disclosure relates to the collection of sonar data from scanning underwater structures to obtain information about the position and orientation of an underwater vehicle relative to the underwater structures.

### BACKGROUND

There are a number of underwater structures and other equipment for which one might need to gain a better understanding. This better understanding can be useful for example to obtain position and orientation information for an underwater vehicle, such as for example navigational purposes. Current methods of inspecting underwater structures include inspections using divers, remotely operated vehicles (ROVs) and autonomous underwater vehicles (AUVs).

### SUMMARY

A method and system is described that can be used for scanning underwater structures, to gain a better understanding of underwater structures, such as for example, for the purpose of avoiding collision of an underwater vehicle with underwater structures and for directing inspection, repair, and manipulation of the underwater structure.

The method and system herein can be used to scan any type of underwater structure. For example, underwater structures include man-made objects, such as offshore oil platform support structures and piers and oil-well related equipment, as well as natural objects such as underwater mountain ranges, and can include structures that are wholly or partially underwater. Underwater structure can also include both stationary and non-stationary structures, for example that may experience drift in the underwater environment. More generally, underwater structure is meant as any arbitrary three dimensional structure with depth variation and that may have varying complexity.

As used herein, the term underwater includes any type of underwater environment in which an underwater structure may be located and may need to be scanned using the system described herein, including, but not limited to, salt-water locations such as seas and oceans, and freshwater locations.

In one embodiment, a method of estimating position and orientation (pose) of an underwater vehicle relative to underwater structures includes directing an acoustic sonar wave toward an underwater structure, and receiving a response from directing the acoustic sonar wave toward the underwater structure. The acoustic sonar is configured as a three dimensional image based sonar, where a pulse at a certain frequency provides data for a receiver to generate a three dimensional image. That is, data points are obtained from the response received by directing the acoustic sonar wave toward the underwater structure, where the data points are configured to provide a three-dimensional image of the underwater structure. The data points obtained are compared to a pre-existing three dimensional model of the underwater structure. Based on the comparison, a determination is made as to the position and orientation of an underwater vehicle relative to the underwater structure.

In some circumstances, it is desirable to have a sonar sensor system, which can carry out the method of estimating position and orientation, onboard an underwater vehicle. The underwater vehicle is, for example, one of an autonomous underwater vehicle (AUV) and a remotely operated underwater vehicle (ROV). As used herein, an ROV is a remotely operated underwater vehicle that is tethered by a cable to a host, such as a surface ship. The ROV is unoccupied and is operated by a pilot aboard the host. The tether can carry, for example, electrical power (in place of or to supplement battery power on the self-contained system), video and data signals back and forth between the host and the ROV. As used herein, an AUV is an autonomous underwater vehicle that is unmanned and is not tethered to a host vessel.

With reference to the sonar system, in one embodiment, such a system for estimating position and orientation of an underwater vehicle relative to underwater structures includes a sensor onboard an underwater vehicle. The sensor is configured to direct an acoustic sonar wave toward an underwater structure. The reflected acoustic sonar wave is processed into a three dimensional image. A data storage is present onboard the underwater vehicle that is configured to receive a response from the sensor. A data processor is also present onboard the underwater vehicle. The data processor is configured to obtain sensor data points from the data storage, where the data points are configured to provide a three-dimensional image of the underwater structure. The processor is configured to compare the data points to a pre-existing three dimensional model of the underwater structure. Based on the comparison, the processor is configured to determine a position and orientation of an underwater vehicle relative to the underwater structure.

### DRAWINGS

FIG. 1 shows a flow diagram of one embodiment of a method for estimating position and orientation of an underwater vehicle relative to underwater structures.

FIG. 2 shows a flow diagram of one embodiment of comparing information from a sonar response to a pre-existing model of an underwater structure, which may be employed in the method shown in FIG. 1.

FIG. 3 shows a flow diagram of a filtering process of information obtained from a sonar response, which may be employed in the method shown in FIG. 1.

FIG. 4 shows a schematic of a system for estimating position and orientation of an underwater vehicle relative to underwater structures.

### DETAILED DESCRIPTION

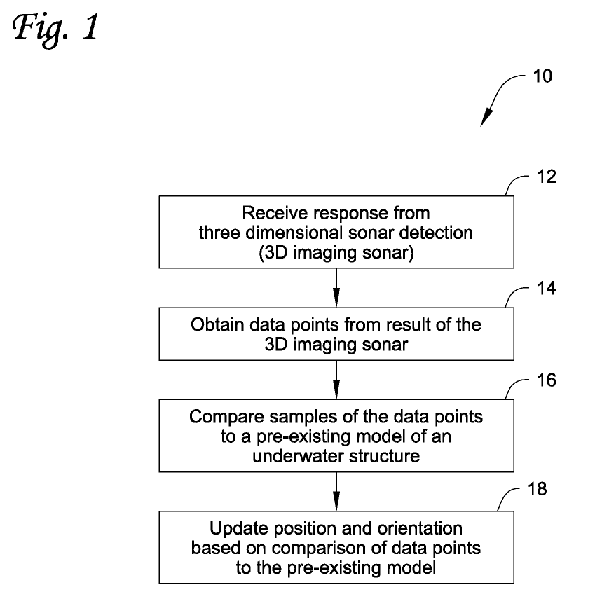

FIG. 1 shows a flow diagram of one embodiment of a method 10 for estimating position and orientation of an underwater vehicle relative to underwater structures. In general, the method is carried out by using an underwater vehicle's inertial navigation capability along with a feature based sensor, e.g. sonar imaging sensor, and a processor that compares the data retrieved by the sensor against a pre-existing three dimensional model of the underwater structure. In many circumstances, this can be performed in real time, often in about one second and sometimes less. For example, the process of sending out a 3D sonar ping, receiving data from it, filtering the data, and aligning it to the prior model may be completed in about one second or less.

The method 10 includes directing an acoustic sonar wave toward an underwater structure. After directing the acoustic sonar wave, a response is received 12 from directing the acoustic sonar wave toward the underwater structure. For example, at 12, a sonar wave is reflected from the structure and received. It will be appreciated that the received acoustic sonar wave is processed by the sonar into a three dimensional image, i.e. the sonar is a three dimensional (3D) imaging sonar. The 3D imaging sonar can be any 3D sonar that creates a 3D image from the reflected sonar signal of a single transmitted sonar pulse or ping. An example of a suitable 3D sonar is the CodaOctopus Echoscope available from CodaOctopus Products. It will be appreciated that the 3D sonar can be arranged such that it points toward an underwater structure so that it can send a ping(s) at the underwater structure and can be oriented at a various desired angles relative to vertical and distances from the underwater structure.

It will be appreciated that inertial navigation systems are known, and are used to determine the position, orientation, and velocity (e.g. direction and speed of movement) of the underwater vehicle. An inertial navigation system can include a Doppler velocity log(DVL) unit that faces downward for use in determining velocity, but it will be appreciated that an inertial navigation system can be any system that can determine position, orientation, and velocity (e.g. direction and speed of movement). An example of a suitable inertial navigation system is the SEADeVil available from Kearfott Corporation.

Once the response is received by the three dimensional imaging sonar, data points are obtained 14 which are configured to provide a three-dimensional image of the underwater structure. The data points are then compared 16 to a pre-existing three dimensional model of the underwater structure. With reference to the comparison step 16, in one embodiment the response from the 3D sonar is aligned with the pre-existing three dimensional image of the underwater structure through an iterative process of fitting the data with the pre-existing three dimensional model. In some embodiments, this iterative process is based on data from a single 3D sonar ping, but it will be appreciated that multiple 3D sonar pings may be used. Based on the comparison, a position and orientation of an underwater vehicle relative to the underwater structure is determined and can be updated 18.

With reference to the pre-existing three dimensional model, it is assumed that a pre-existing three dimensional model is available for comparison to the data retrieved by the 3D sonar. It will be appreciated that the source of the pre-existing three dimensional model can vary. In one example, the pre-existing three dimensional model is present at the time of initiating an estimation of position and orientation of the underwater vehicle, such as for example from an electronic file available from computer aided design software. This may be the case, for example, when a first reference model of the underwater structure is used to carry out later comparisons of the model structure. In other examples, the pre-existing three dimensional model is available after generating a three-dimensional image of the underwater structure or updating the position and orientation, which is conducted by a first iteration of the steps 12, 14, 16, and 18. Subsequent iterations that further update the position, orientation, and model structure by matching to the model of the first iteration or other earlier iteration can be used as the pre-existing three dimensional model for subsequently received sonar data.

That is, in some cases, at initial startup the first reference may be from an electronic file already available, and once the 3D sonar has retrieved data, subsequent updates on the position and orientation can be used for further comparisons.

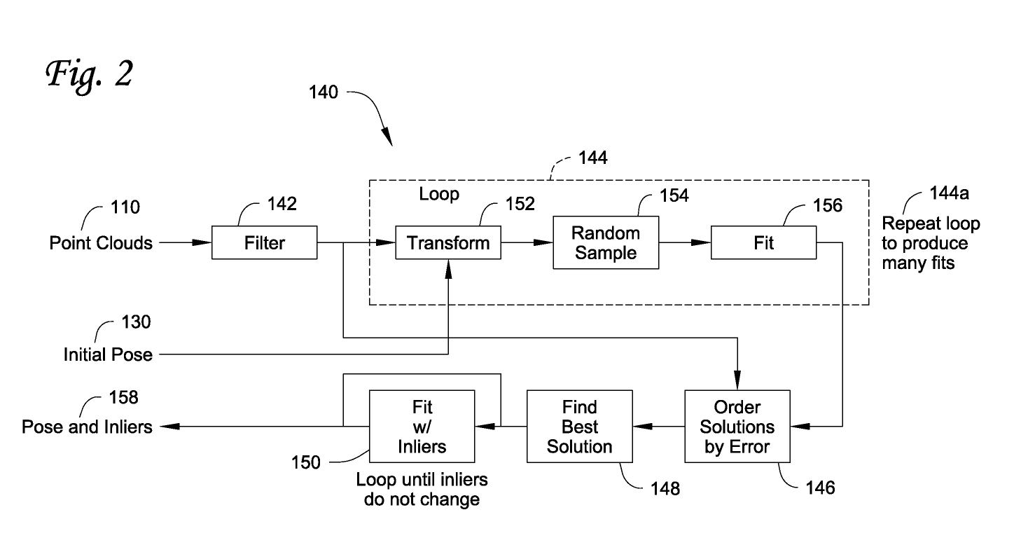

With further reference to the comparing step 16, FIG. 2 shows a flow diagram of one embodiment of comparing information from a sonar response to a pre-existing model of an underwater structure. In the embodiment shown, the step of comparing the data points includes aligning a sample of the data points to the pre-existing three dimensional model of the underwater structure. As shown, the step of aligning includes an iterative method of repeatedly performing a fit processing based on multiple samples of the data points, which is further described below, and where the fit processing includes adjusting the data points sampled to match with the pre-existing three dimensional model of the underwater structure.

With reference to the details of FIG. 2, the response from the 3D sonar provides point clouds 110 that are used to perform the alignment process. The point clouds include data points which represent a 3D image of the underwater structure. Due to a usual high level of noise and potential non-useful information that is known to occur in 3D sonar point clouds, the data points in some circumstances are filtered 142 before undergoing alignment.

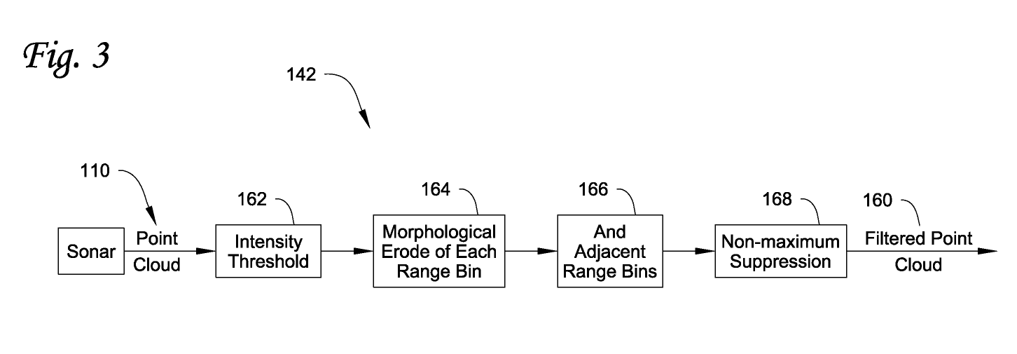

FIG. 3 shows a flow diagram of one embodiment of the filtering process 142, which may be included as part of the step of obtaining the data points 14 shown in FIG. 1. Filtering process 142 includes filtering the response received from directing the acoustic sonar wave toward the underwater structure, so as to obtain data points useful during alignment. The data from the sonar point cloud 110 is input through a series of data processing and filtering steps, which result in a filtered point cloud 160. In the embodiment shown, the point cloud 110 is input to an Intensity Threshold filter 162. Generally, the filtering process 142 performs morphological operations on the point cloud 110. For example, a Morphological Erode of Each Range Bin 164 is performed, and then Adjacent Range Bins 166 are combined. Box 164 and 166 represent non-limiting examples of certain morphological operations used by the filtering process 142. Next, a Non-maximum Suppression 168 step is performed before the filtered point cloud 160 is obtained. In box 168, the filter process 142 may perform a beam width reduction/compensation processing.

With further reference to FIG. 2, the filtered point cloud 160 proceeds to a processing loop 144. In one embodiment, the processing loop 144 is a RANSAC loop, i.e. random sample consensus, which is an iterative method to estimate parameters of a mathematical model from a set of observed data which contains “outliers”. For example, the loop 144 represents a non-deterministic algorithm in the sense that it produces a reasonable result with a certain probability, and where the probability can increase as more iterations are performed. In this case, the parameters of the mathematical model are the position and orientation (pose) of the 3D sonar sensor relative to the pre-existing model of the underwater structure, and the observed data are the 3D points from the sonar. A basic assumption is that the observed data consists of “inliers”, i.e., data that can be explained by the mathematical model with some pose parameters, and “outliers” which are data that cannot be thus explained. As a pre-existing three dimensional model is available in the method herein, such an iterative process, given a small set of inliers can be used to estimate the parameters of a pose by computing a pose that fits the data (i.e. 3D sonar data points) optimally to their corresponding closest model points.

As shown in FIG. 2, the loop 144 is a RANSAC loop that includes processing functions Transform 152, Random Sample 154, and Fit 156. In the Transform 152 portion, the point clouds undergo transformation to a coordinate system specified by the initial pose 130 that brings them into approximate alignment with the pre-existing three dimensional model.

As further shown in FIG. 2, an initial pose 130 is input into the Transform 152 portion. In some instances, the initial pose 130 represents the position and orientation from an underwater vehicle's inertial navigation system. In subsequent iterations, the initial pose can be the result from updated knowledge of the first or any preceding alignment that has occurred, while undergoing the procedure shown by FIG. 2. It will be appreciated that a preceding alignment can be appropriately adjusted based on other measurements, such as inertial velocity or acceleration and other inputs from the underwater vehicle's inertial navigation system.

With reference to the available pre-existing 3D model, the pre-existing 3D model is input to the diagram at 146, 156 and 150, and further described as follows.

In the Random Sample 154 portion of the loop 144, a sample of the points from the point cloud is obtained for further processing and comparison with the pre-existing three dimensional model. The Fit 156 portion of the loop 144 is where the points sampled from Random Sample 154 are adjusted to line up with the pre-existing three dimensional model. That is, the collective position (pose) of the 3D sonar data, e.g. data points, is rigidly adjusted to align the points with the pre-existing three dimensional model. In the Fit 156 portion, the data points can undergo one or more closest point calculations to determine the closest point on the model. The data points and the closest point on the model for each data point are used to compute the correction to the initial pose 130 that optimally aligns the data points and closest points on the model for each data point.

As described, the alignment process is an iterative method to determine a correction to the initial pose 130 that aligns as many points of the 3D sonar data as possible (the inliers) with the pre-existing three dimensional model. In some embodiments, this is achieved from a single ping or detection from the 3D sonar, for example data points from a single acoustic sonar pulse, from which the data point samples are taken. It will also be appreciated that multiple pings of 3D sonar may be employed as needed.

Thus, it will be appreciated that the functions Transform 152, Random Sample 154, and Fit 156 are configured as a loop 144 that can be repeated 144a as necessary to raise the confidence that the best alignment of the 3D sonar data with the pre-existing three dimensional model found in these iterations is truly the best possible alignment. The step of aligning in many embodiments includes repeatedly performing a fit processing based on multiple samples of the data points or data points from multiple acoustic sonar pulses, where the fit processing includes adjusting the data points sampled to align with the pre-existing three dimensional model of the underwater structure. It will be appreciated that in appropriate circumstances, the multiple samples of data points or data points from multiple acoustic sonar pulses that go through the loop 144a can often have overlapping data points, where such overlap can further help increase the probability of finding the best possible alignment of the data points with the model.

That is, the fit is done using a subsample of the data points. Fit uses these points to estimate the pose of the sensor relative to the model. This estimated transform is applied to all data points. The transformed points are then compared to the pre-existing model to determine how well the data matches.

It will also be appreciated that the number of iterations that is appropriate and the amount of overlap used to carry out the alignment and fit can depend upon a balance of several factors. Some factors can include, but are not limited to for example, the amount of processing power employed, how much time is used to collect data, reliability of the data collected and the pre-existing model available, how the underwater vehicle is moving, and the complexity of the underwater structure. Where more than one 3D sonar ping is employed, other factors such as for example, the ping rate of the 3D sonar, the potential increase in the initial pose 130 error over time, and the accuracy of the model can be considered in determining how many iterations of the alignment process are needed.

After many random samples of data points have been fitted, a number of solutions can be obtained. FIG. 2 shows portions Order Solutions by Error 146 and Find Best Solution 148. The solutions provided by the loop 144a are ordered (e.g. at 146) so that the best solution can be obtained (e.g. at 148). Once the best solution is obtained, the closest points on the pre-existing 3D model to each of the inliers of this solution are determined, and the correction to the initial pose that best aligns these inliers with the closest points is computed at Fit w/ Inliers 150. The updated pose is sent, for example, back to the underwater vehicle's inertial navigation system.

It will be appreciated that the methods of estimating position and orientation herein are provided in a system onboard an underwater vehicle. In some embodiments, the underwater vehicle is one of an autonomous underwater vehicle and a remotely operated underwater vehicle. However, the system may be onboard other vehicles.

In one embodiment, the system includes a 3D sonar sensor and an inertial navigation system, along with suitable processing capability to carry out the estimation of position and orientation. This combination of features permits the system to be used to, for example, navigate an underwater vehicle relative to underwater structures.

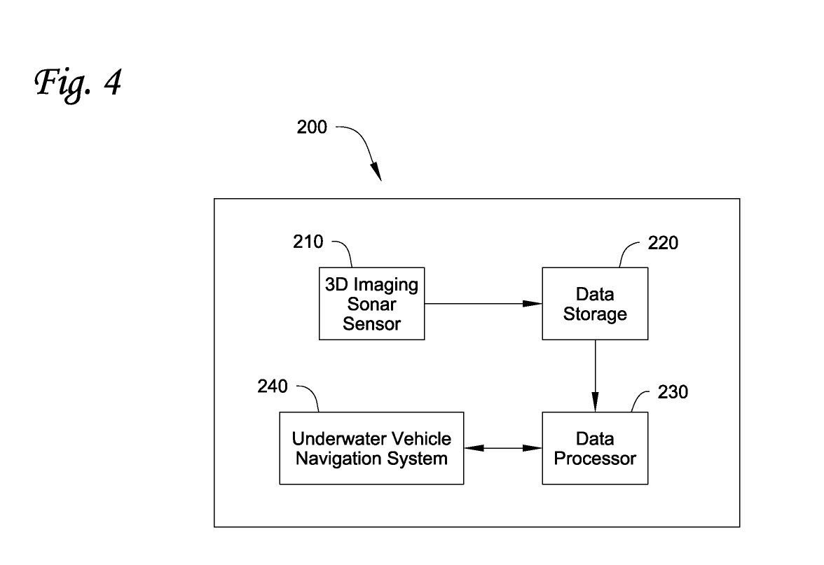

FIG. 4 shows a schematic of a system 200 for estimating position and orientation of an underwater vehicle relative to underwater structures. In appropriate circumstances, the system 200 is onboard and part of an underwater vehicle.

In the embodiment shown, a 3D imaging sonar sensor 210 can transmit a response from a 3D sonar ping to a data storage 220. The sensor 210 is configured to direct an acoustic sonar wave toward an underwater structure, and to process the acoustic sonar wave reflected from the underwater structure into a three dimensional image of the structure. The data storage 220 is configured to receive a response from the sensor.

A data processor 230 is configured to obtain data points from the data storage 220. The data processor 230 can be, for example, any suitable processing unit. The data points are configured to provide a three-dimensional image of the underwater structure. The processor 230 is configured to compare the data points obtained to a pre-existing three dimensional model of the underwater structure. Based on the comparison, the processor 230 is configured to determine a position and orientation of an underwater vehicle relative to the underwater structure. The position and orientation can be used to update the underwater vehicle navigation system 240 which is, for example, an inertial navigation system. It will be appreciated that the components of the system 200 can be powered by the underwater vehicle.

The methods and systems described herein above can be used to navigate an underwater vehicle relative to an underwater structure based on features of the underwater structure from the 3D sonar scans. In one embodiment, data from 3D sonar scans is collected, data from inertial navigation is collected, the data is logged and processed to compare the 3D image of the scanned underwater structure with a pre-existing three dimensional model of the underwater structure. The collection, logging and processing of the data can be performed using the data processing electronics onboard the underwater vehicle.

The methods and systems described herein above can be useful, for example, in situations where an underwater vehicle is far from the seafloor, for example over 1000 meters, such that other navigation tools, such as DVL are unavailable. It will be appreciated that no other feature based sensors are necessary and that navigation relative to non-stationary underwater structures may also be possible using the methods and systems herein. The use of 3D sonar allows scanning of complex 3D structures to provide a full six degrees of freedom in pose.

The examples disclosed in this application are to be considered in all respects as illustrative and not limitative. The scope of the invention is indicated by the appended claims rather than by the foregoing description; and all changes which come within the meaning and range of equivalency of the claims are intended to be embraced therein.

1. A method of estimating position and orientation of an underwater vehicle relative to underwater structures comprising:
directing an acoustic sonar wave toward an underwater structure;
receiving the acoustic sonar wave reflected from the underwater structure,
obtaining 3D data points from the acoustic sonar wave reflected from the underwater structure, the 3D data points are configured to provide a three-dimensional image of the underwater structure;
comparing data points obtained to a pre-existing three dimensional model of the underwater structure; and
based on the comparison, determining a position and orientation of an underwater vehicle relative to the underwater structure.

2. The method of claim 1, wherein the underwater structure is non-stationary.

3. The method of claim 1, wherein the underwater vehicle is one of an autonomous underwater vehicle and a remotely operated underwater vehicle.

4. The method of claim 1, wherein the step of obtaining the 3D data points comprises filtering the 3D data points received from the acoustic sonar wave.

5. The method of claim 1, wherein the step of comparing the 3D data points comprises aligning a sample of the data points from a single acoustic sonar pulse to the pre-existing three dimensional model of the underwater structure.

6. The method of claim 5, wherein the step of aligning comprises repeatedly performing a fit processing on data points from multiple acoustic sonar pulses, the fit processing comprises adjusting the data points sampled to match with the pre-existing three dimensional model of the underwater structure.

7. The method of claim 6, wherein the data points from multiple acoustic sonar pulses have overlapping data points.

8. The method of claim 1, wherein the pre-existing three dimensional model is present at the time of initiating an estimation of position and orientation of the underwater vehicle.

9. The method of claim 1, wherein the pre-existing three dimensional model is present after completing an iteration of directing, receiving, obtaining, comparing, and determining.

10. A system for estimating position and orientation of an underwater vehicle relative to underwater structures comprising:
a sensor onboard an underwater vehicle, the sensor is configured to direct an acoustic sonar wave toward an underwater structure, the reflected acoustic sonar wave being processed to produce a three dimensional image;
a data storage onboard the underwater vehicle that is configured to receive a response from the sensor; and
a data processor onboard the underwater vehicle,
the data processor is configured to obtain 3D data points from the data storage, the data points are configured to provide a three-dimensional image of the underwater structure,
the processor is configured to compare the data points obtained to a pre-existing three dimensional model of the underwater structure, and
based on the comparison, the processor is configured to determine a position and orientation of an underwater vehicle relative to the underwater structure.
